(19) United States
(12) Patent Application Publication
(10) Pub. No.: US 2017/0279549 A1
(43) Pub. Date: Sep. 28, 2017

(54) CUSTOMIZED MEDIA CONTENT DELIVERY SYSTEM AND METHOD

(71) Applicant: GM GLOBAL TECHNOLOGY OPERATIONS LLC, Detroit, MI (US)

(72) Inventors: MICHAEL KOCHEISEN, MOUNTAIN VIEW, CA (US); GREGORY A. ROSS, BEVERLY HILLS, MI (US)

(73) Assignee: GM GLOBAL TECHNOLOGY OPERATIONS LLC, Detroit, MI (US)

(21) Appl. No.: 15/078,893

(22) Filed: Mar. 23, 2016

(51) Int. Cl. H04H 20/10; H04H 20/57; H04H 20/38

(52) U.S. Cl. CPC H04H 20/103; H04H 20/38; H04H 20/57

(57) ABSTRACT

Methods, systems, and vehicles are provided that utilize a communication system that may include infotainment systems and telematics systems along with land network and call center functions to target audio content to an occupant of the vehicle, e.g., the driver or a passenger. The systems, methods and vehicle may seamlessly replace broadcast content segments of broadcast programming with targeted content.

### TECHNICAL FIELD

The technical field generally relates to vehicle infotainment and telematics systems, and more particularly, the technical field relates to systems and methods to target media content for delivery to a vehicle occupant via a system that has both broadcast reception and data communication capability.

### BACKGROUND

Broadcast entertainment is an automotive vehicle staple providing a large variety of content: music, talk, news, sports, weather and traffic and more. This variety of content can be delivered via local broadcast radio station operators broadcasting on the AM or FM bands in standard and/or high-definition formats, and via satellite operators using satellite radio transmission. Broadcast entertainment reaches a large listening population, is very easy to use and has a high level of customer acceptance. Broadcast by its nature, however, makes it difficult to target specific content to listeners. All listeners tuned to a particular station or channel hear the same audio content including the same advertising content, for example. Broadcast entertainment also does not lend itself to receiving listener data or listener feedback, and there is no direct way of knowing listener profiles, interests or behaviors.

Vehicle telematics systems may incorporate data communications technology that permit an interactive vehicle driver/occupant experience among other user entertainment enhancements. Such vehicle telematics systems, which include in-vehicle data communication capability, may use broadband cellular data communication technology, such as provided by fourth generation, long-term evolution (4G/LTE) communication networks, to provide on-demand audio and video streaming, Internet browsing and the like. These data communication systems further enable user feedback and collection of user profile data. Compared to AM/FM broadcast and even satellite broadcast entertainment; however, broadband data delivered entertainment is relatively expensive, and can be inefficient.

Accordingly, it is desirable to provide systems and methods to enhance broadcast entertainment to include targeted content to a vehicle user or occupant via vehicle infotainment and telematics systems. It is also desirable to provide methods, systems, and vehicles incorporating such systems and utilizing such methods. Furthermore, other desirable features and characteristics of the present invention will be apparent from the subsequent detailed description and the appended claims, taken in conjunction with the accompanying drawings and the foregoing technical field and background.

### SUMMARY

Methods and systems for providing targeted content to a vehicle occupant and vehicles employing such methods and systems are disclosed herein.

In a first non-limiting embodiment, the method includes, but is not limited to, receiving within the vehicle a first stream of broadcast content segments. The method further includes, but is not limited to, receiving within the vehicle a second stream of targeted content segments. The method further includes, but is not limited to, identifying a segment of the broadcast content segments for replacement with a targeted content segment to provide an identified segment. The method further includes, but is not limited to replacing the identified segment with the targeted content segment to provide a modified content stream. The method still further includes, but is not limited to rendering the modified content stream as audio to the vehicle occupant.

In another non-limiting embodiment, the system includes, but is not limited to, a first system portion. The first system portion is configured to receive a stream of broadcast program segments. The system further includes, but is not limited to, a second system portion. The second system portion is configured to receive a stream of targeted content segments. The system further includes, but is not limited to, an audio component operatively coupled to the first system portion and the second system portion and to a speaker. The audio component is configured to insert a targeted content segment of the targeted content segments in place of an identified segment of the stream of broadcast program segments providing a modified content stream to the speaker. The speaker is operable to render the modified content stream as an audio to vehicle occupant.

In another non-limiting embodiment, the vehicle includes, but is not limited to, a system to provide targeted content to an occupant of the vehicle. The system includes, but is not limited to, a first system portion. The first system portion is configured to receive a stream of broadcast program segments. The system further includes, but is not limited to, a second system portion. The second system portion is configured to receive a stream of targeted content segments. The system further includes, but is not limited to, an audio component operatively coupled to the first system portion and the second system portion and to a speaker. The audio component is configured to insert a targeted content segment of the targeted content segments in place of an identified segment of the stream of broadcast program segment providing a modified content stream to the speaker. The speaker is operable to render the modified content stream as an audio to vehicle occupant.

### DESCRIPTION OF THE DRAWINGS

One or more examples will hereinafter be described in conjunction with the following drawing figures, wherein like numerals denote like elements, and

FIG. 1 is a graphic depiction of a communication system that may be adapted in accordance with herein described non-limiting embodiments;

FIG. 2 is a graphic depiction of a portion of the communication system of FIG. 1, in accordance with herein described non-limiting embodiments;

FIG. 3 a schematic timing illustration of broadcast content and customized content seamlessly incorporated with the broadcast content, in accordance with a non-limiting example; and

FIG. 4 is a flow chart illustrating a method in accordance with a herein described non-limiting embodiment.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

Methods, systems, and vehicles are provided that utilize a communication system that may include infotainment systems and telematics systems along with land network and call center functions to target audio content to an occupant of the vehicle, e.g., the driver or a passenger.

In a first non-limiting example, a method is provided that seamlessly replaces specific content segments of broadcast programming received within the vehicle with customized, targeted content that has been received within the vehicle. The broadcast programming may be vehicle driver/occupant selected, while the targeted content may be selected based upon driver/occupant related demographics. The targeted content may be delivered to the vehicle via a data connection.

In another non-limiting example, a system is provided that communicates broadcast programming and seamlessly integrated targeted content via vehicle entertainment and telematics systems to a driver and/or occupant of the vehicle. The broadcast programming may be driver/occupant selected, while the targeted content may be selected based upon vehicle, driver/occupant related parameters.

In another non-limiting example, a vehicle is provided. The vehicle includes a broadcast receiver as a component of an in-vehicle infotainment (IVI) system and a telematics system capable of sending/receiving data from/to the vehicle. The IVI system and the telematics system cooperate to seamlessly replace specific content segments of broadcast programming with targeted content. The broadcast programming may be vehicle driver/occupant selected, while the targeted content may be selected based upon driver/occupant related parameters. The targeted content may be delivered to the vehicle via a data connection.

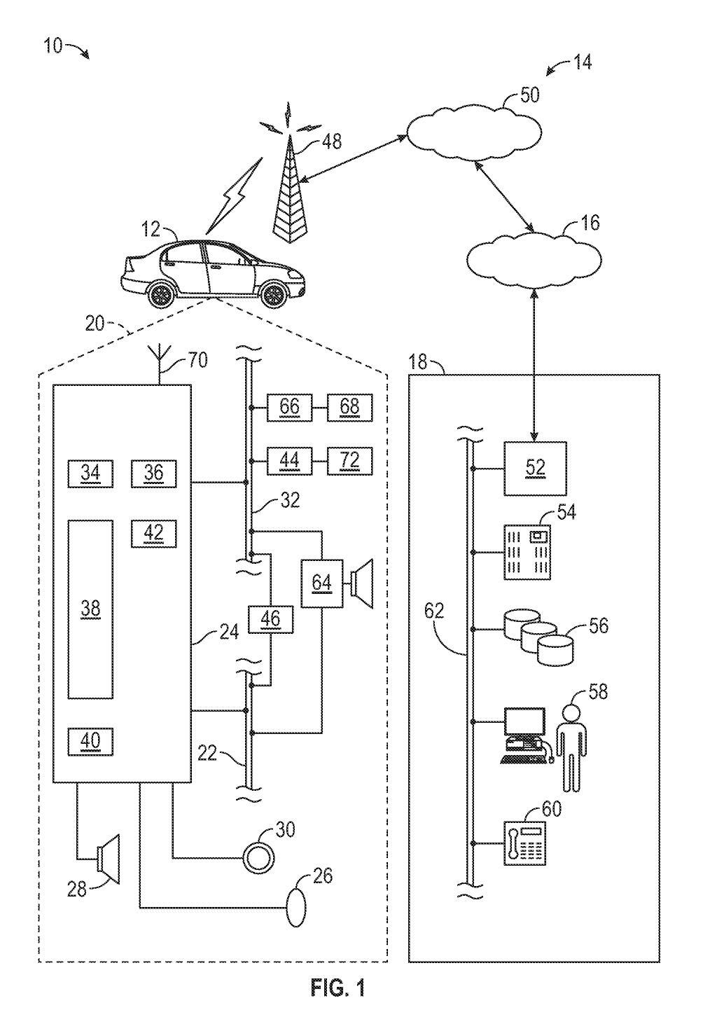

With reference to FIG. 1, there is shown a non-limiting example of a communication system 10 that may be used together with examples of the apparatus/system disclosed herein or to implement examples of the methods disclosed herein. Communication system 10 generally includes a vehicle 12, a wireless carrier system 14, a land network 16 and a back office 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the back office 18, and generally includes an electronic processing device 38, one or more types of electronic memory 40, a cellular chipset/component 34, a wireless modem 36, an antenna 70, and a navigation unit containing a GPS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback, and as will be described, occupant specific, occupant targeted content. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a connection with wireless carrier system 14 so that both voice and data transmissions can be sent and received. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc.

Antenna 70 services the GPS chipset/component 42, the cellular chipset/component 34 and other radio transmissions.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and back office 18 to communicate with the occupants through audible speech. The vehicle hardware and in particular the HMI may also include one or more buttons and/or controls 30 for enabling a vehicle occupant to activate or engage one or more of the vehicle hardware components 20. For example, one of the buttons and/or controls 30 may be touch screen activated or electronic pushbuttons used to initiate voice communication with back office 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, such as analog broadcast content via a broadcast source 74, rendering it as sound via the audio bus 22. Digital information is received via the vehicle bus 32. The audio component 64 provides amplitude modulated (AM) and frequency modulated (FM) radio, satellite broadcast radio, compact disc (CD), digital video disc (DVD), and multimedia functionality independent of the infotainment center 46. Audio component 64 may contain a speaker system 76, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14.

Land network 16 can be a conventional land-based telecommunications network that is connected to one or more landline telephones, and that connects wireless carrier system 14 to back office 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof

Back Office 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various back office components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a back office 18 that is manned, it will be appreciated that the back office 18 can be any central or remote facility, manned or unmanned, mobile or fixed, to or from which it is desirable to exchange voice and data.

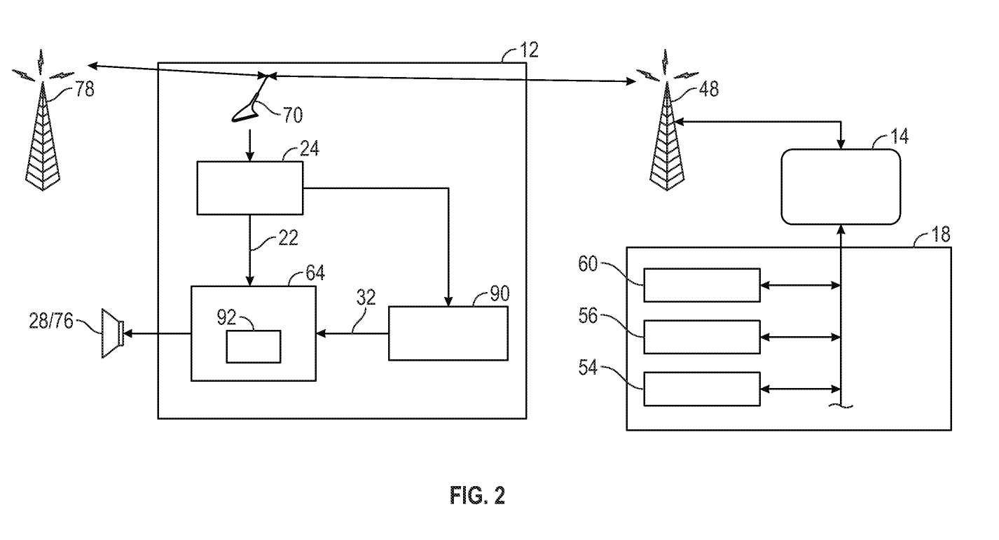

With reference to non-limiting example of a portion of the system 10 depicted in FIG. 2, to provide targeted content to an occupant, e.g., the driver and/or a passenger, of the vehicle 12, targeted audio content is communicated from the back office 18 to the telematics unit 24, for example, via the system 14. The telematics unit 24 processes the received targeted content, e.g., decodes received data, and provides the targeted content to the audio component 64 via the vehicle bus 32. The telematics unit 24 may include a targeted content processor 90 to receive the targeted content stream 85 and hence the targeted content segments 86. The targeted content processor may also be hosted in a separate unit or could be included in the audio component 64. To provide the targeted content processor 90 the electronic processing device 38 may be operatively configured in accordance with one or more control programs retained within the one or more types of electronic memory 40. The targeted content processor 90 provides the targeted content to the audio component 64 via the bus 32.

The audio component 64 selectively includes the targeted content within broadcast content received via the bus 22 or from other sources, and renders the combined content, broadcast and targeted content as a modified stream of segments for communication to the occupant as audio via the speaker 28 and/or speaker 76. To the occupant the selective combination of the targeted content with the broadcast content is seamless, and preferably, without any perceptible breaks or changes in audible characteristics such as volume and tone.

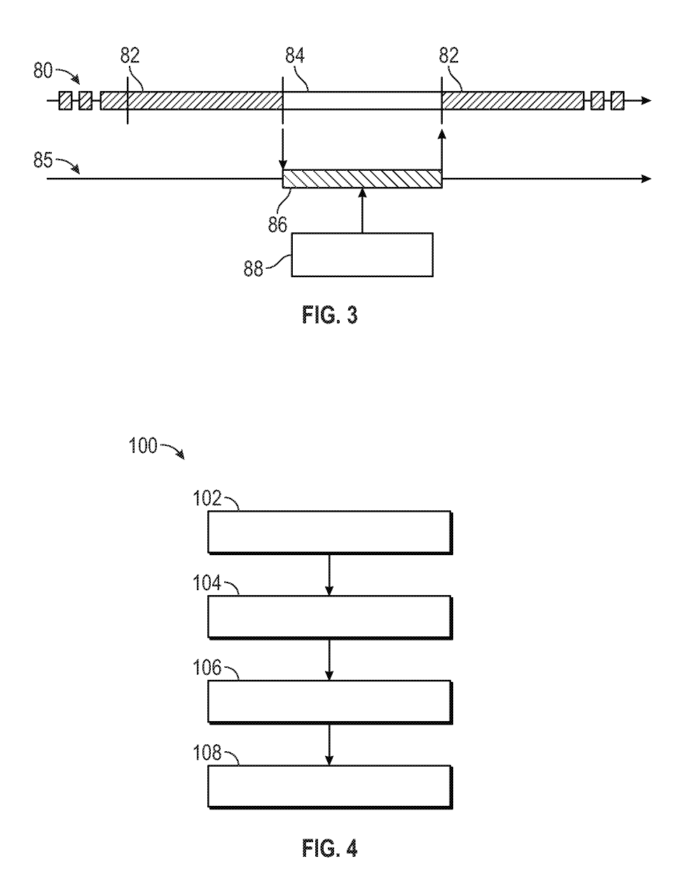

FIG. 3 illustrates a non-limiting example of a process to seamlessly provide targeted audio content within broadcast audio content. Broadcast audio stream 80 may be broken into segments, a portion of which are identified for illustrative purposes as segments 82 and 84. The three segments “n−1”, “n” and “n+1” are depicted enlarged relative to the entire stream of segments to facilitate the following discussion. The segments “n−1” and “n+1” 82 represent program content, such as, music, sports, news, talk and the like. The segment “n” 84 represents program content that can/should be replaced with targeted content, such as, advertising, public service announcements, weather reports, pledge drives entreaties, sporting event scores and updates and the like, type content. A second content stream 85 is provided to the audio component 64 via the telematics unit 24. The stream 85 contains a plurality of targeted content segments, one of which is depicted as targeted content segment 86. The audio component 64 is operatively configured to identify the program content segment targeted for replacement 84 and to insert the targeted content segment 86 in place of segment “n” 84 to provide a modified content stream. The audio component 64 then delivers the modified content stream to the speakers 28/76 to render as audio to the occupant. As a result, the occupant of the vehicle 12 hears a continuous audio program consisting of program content segments 82 and targeted content 86. It will be appreciated that, a single segment 84 may be replaced with a plurality of targeted content segments 86, a plurality of non-program segments 84 may be replaced with a single targeted content segment 86, a plurality of segments 84 may be replaced with a plurality of targeted content segments 86, and combinations thereof as may occur at various times during a broadcast program.

The targeted content 86 may be selected based on a set of vehicle/driver/occupant related parameters 88, for example, driver or occupant identification, location, driving direction, weather conditions, driving behavior, make/model of the vehicle, age of the vehicle, service/maintenance needs, and virtually any demographic or combinations of demographics. Occupants may be identified based upon a number of parameters, such as owner, primary driver, active key fob, broadcast program type and content, and the like which may be stored as subscriber data within one or more of the databases 56. Drivers and occupants may self-identify via the human/machine interface (e.g., microphone 26 and/or touch screen, hard buttons and other controls 30) of the telematics unit 24, or, may indicate interest or disinterest in targeted content 86 by using the human/machine interface to provide a signal back to the back office 18. Vehicle occupants may be identified from data received from paired or coupled smart devices within the vehicle. Identification of occupants may further be made by facial recognition or other biometric methods, and the skilled person will appreciate that virtually any method of identification may be used.

The servers 54, databases 56 and computer equipment 60 within back office 18 may be operatively configured and cooperate to store, select, process and cause to be communicated to the vehicle 12 data reflecting the targeted content 86 within the stream 85. The targeted content 86 is intended to be of increased interest to a vehicle 12 occupant, and therefore may be distinguished from general broadcast content, such as broadcast advertisements or announcements. Broadcasters themselves may be willing to cooperate with targeted content providers as a way of increasing advertising interest and thus their ability to charge advertisers. Providing targeted content may make broadcasts more interesting and informative to listeners, increasing listenership and further permitting broadcasters to charge increased advertising rates. Additionally, the targeted content provider may itself charge a fee for the service. Thus there exists numerous opportunities to monetize systems, methods and vehicles in accordance with the herein described non-limiting embodiments.

The targeted content 86 may be messaging directed toward a particular demographic with which a vehicle occupant correlates. The targeted content 86 may be information regarding the vehicle itself, such as service reminders and special service offers. The targeted content may be location based and indicate available local attractions, features and services. The skilled person will appreciate that the targeted content 86 may be virtually any content or combinations of content that may be determined to be of interest to a vehicle occupant and delivered to the occupant as an audio insert to a broadcast program.

The audio component 64 is operatively configured to identify the non-program content segment “n” 84 from program content segments “n−1” and “n+1” 82 and to insert targeted content 86. The audio component 64 may be configured with an audio router 92. The audio router 92 may be configured to receive broadcast AM/FM/satellite and hence the broadcast content stream 82. The audio router 92 further receives the targeted content segments 86. The audio router 92 then replaces the non-program content segments 84 with the targeted content segments 86 and provides the modified stream to the speakers 28/76 to render as audio.

Identification of the non-program content “n” 84 may be facilitated by the broadcaster inserting identifying data, tones or other content within the non-program content segment “n” 84 that the audio component 64 may be configured to detect. The audio component 64 may additionally or alternatively detect non-program content based upon the content itself in comparison to known non-program content data samples or in contrast to the program content. Alternatively, insertion can be trigged by an external signal received via the telematics unit 24 from the back office 18 or any other source, or insertion can be trigger based on timing information. To facilitate seamless insertion of targeted content 86, the targeted content processor 90 may buffer targeted content segments. Additionally, the audio component 64 may be configured to forward sample the broadcast program content to anticipate the time for insertion of the targeted content 86. The audio component 64 may additionally introduce a delay to the program content, again to facilitate identification of the non-program content segment “n” 84 and to insert the targeted program content 86.

The systems and methods of the herein described, non-limiting embodiments may be used to enable broadcasters to deliver customized advertisement to a vehicle occupant as part of a standard AM/FM/satellite broadcast. Various properties, parameters and inputs may be used to identify specific vehicle occupants so that customized content may be downloaded/streamed from a server and inserted into the live broadcast stream replacing standard advertisement.

With reference to FIG. 4, a non-limiting embodiment of a method 100 in accordance with herein described embodiments is shown. At 102, with the vehicle 12, a first stream of broadcast content segments 82 and a second stream of targeted content segments 86 are received. At 104, a segment, non-program content segment 84, of the broadcast content segments is identified for replacement with a targeted content segment 86 to provide an identified segment. At 106, the identified segment is replaced with the targeted content segment 86 to provide a modified content stream. At 108, the modified content stream is rendered as audio to the vehicle occupant.

It will be appreciated that the disclosed methods, systems, and vehicles may vary from those depicted in the Figures and described herein. For example, the communication system 10, the vehicle 12, back office 18, the telematics unit 24, the audio component 64, and/or various components thereof may vary from that depicted in FIGS. 1 and 2 and described in connection therewith. In addition, it will be appreciated that the process may vary from that depicted in FIG. 3.

While at least one example has been presented in the foregoing detailed description, it should be appreciated that a vast number of variations exist. It should also be appreciated that the example or examples are only examples, and are not intended to limit the scope, applicability, or configuration of the disclosure in any way. Rather, the foregoing detailed description will provide those skilled in the art with a convenient road map for implementing the example or examples. It should be understood that various changes can be made in the function and arrangement of elements without departing from the scope of the appended claims and the legal equivalents thereof

1. A method for providing targeted content to a vehicle occupant, the method comprising:
detecting biometric information of the vehicle occupant and identifying the vehicle occupant based upon the biometric information;
receiving within the vehicle a first stream of broadcast content segments and a second stream of targeted content segments;
identifying a segment of the broadcast content segments for replacement with a targeted content segment to provide an identified segment;
replacing the identified segment with the targeted content segment to provide a modified content stream, the targeted segment being targeted to the vehicle occupant based upon the biometric information; and
rendering the modified content stream as audio to the vehicle occupant.

2. The method of claim 1, wherein replacing the identified segment with the targeted content segment is seamless to the occupant.

3. The method of claim 1, further comprising:
selecting targeted content segments based upon a demographic associated with the occupant.

4. The method of claim 3, wherein the demographic comprises one of locally stored or transmitted to the vehicle from a back office, driver or passenger identification, driver or passenger profile, vehicle location, vehicle driving direction, weather condition, traffic conditions, driving behavior, make and model of the vehicle, age of the vehicle and a service/maintenance need of the vehicle.

5. The method of claim, wherein identifying the occupant further comprises one of: receiving data from the occupant; detecting a wireless transmission, and detecting a smart device within the vehicle.

6. The method of claim 1, further comprising buffering a plurality of targeted content segments.

7. The method of claim 1, wherein the targeted content segments comprise information regarding one of: the vehicle, a service reminder, a service offer, a location based service, a location based attraction, a location based feature and a location based service.

8. The method of claim 1, wherein identifying a segment of the broadcast content segments for replacement with a targeted content segment comprises one of providing an indication contained within the identified segment, providing an external signal to the vehicle and providing a timing signal.

9. A system for delivering targeted content to a vehicle occupant, the system comprising:
a first system portion, the first system portion being configured to receive a stream of broadcast program segments;
a second system portion, the second system portion being configured to receive a stream of targeted content segments; and
an audio component operatively coupled to the first system portion and the second system portion and to a speaker, wherein
one of the first system portion and the second system portion is operably configured to identify an occupant of the vehicle based upon detected biometric information about the occupant, and the audio component is configured to insert a targeted content segment of the targeted content segments based upon the vehicle occupant as identified by the biometric information in place of an identified segment of the stream of broadcast program segment providing a modified content stream to the speaker, and the speaker being operable to render the modified content stream as an audio to the vehicle occupant.

10. The system of claim 9, the audio component being operable to seamlessly insert the targeted content segment of the targeted content segments in place of the identified segment.

11. The system of claim 9, wherein the targeted content segment is based upon a demographic associated with the occupant.

12. The system of claim 11, wherein the demographic comprises one of locally stored or transmitted to the vehicle from a back office, driver or passenger identification, driver or passenger profile, vehicle location, vehicle driving direction, weather condition, traffic conditions, driving behavior, make and model of the vehicle, age of the vehicle and a service/maintenance need of the vehicle.

13. The system of claim 11, wherein the one of the first system portion and the second system portion is operably configured to identify the occupant based upon received data from the occupant, a detected wireless transmission, and a detected smart device within the vehicle.

14. The system of claim 9, wherein the second system portion is operable to buffer a plurality of the targeted content segments.

15. The system of claim 9, wherein the targeted content segment comprises information regarding one of: the vehicle, a service reminder, a service offer, a location based service, a location based attraction, alternative programming, a location based feature and a location based service.

16. The system of claim 9, wherein the identified segment comprises an identifier.

17. The system of claim 9, wherein the first system portion and the second system portion are portions of a telematics unit.

18. A vehicle comprising:
a system to provide targeted content to an occupant of the vehicle, wherein the system includes:
a first system portion, the first system portion being configured to receive a stream of broadcast program segments;
a second system portion, the second system portion being configured to receive a stream of targeted content segments; and
an audio component operatively coupled to the first system portion and the second system portion and to a speaker, wherein
one of the first system portion and the second system portion is operably configured to identify an occupant of the vehicle based upon detected biometric information about the occupant, and the audio component is configured to insert a targeted content segment of the targeted content segments based on the vehicle occupant as identified based upon the biometric information in place of an identified segment of the stream of broadcast program segment providing a modified content stream to the speaker, and the speaker being operable to render the modified content stream as an audio to vehicle occupant.

19. The vehicle of claim 18, wherein the first system portion and the second system portion are portions of a telematics unit.

20. The vehicle of claim 19, wherein the telematics unit is operable to transmit and receive data from a call center.
